(19) United States
(12) Patent Application Publication
(10) Pub. No.: US 2026/0268634 A1
(43) Pub. Date: Sep. 10, 2026

(54) INTEGER-BASED SAMPLING OF BINARY DESCRIPTORS FROM QUANTIZED TENSORS

(71) Applicant: QUALCOMM Incorporated, San Diego, CA (US)

(72) Inventors: Andrii MAIDAN, Madrid (ES); Iago SUAREZ, Madrid (ES); Maksym RAITAROVSKYI, Madrid (ES); Kostiantyn ANTONIUK, Kyiv (UA)

(21) Appl. No.: 19/075,581

(22) Filed: Mar. 10, 2025

(51) Int. Cl. G06V 10/28; G06V 10/77; G06V 10/82

(52) U.S. Cl. CPC G06V 10/28; G06V 10/7715; G06V 10/82

(57) ABSTRACT

Systems and techniques are described for image processing. For example, a computing device can generate, using a machine learning network based on image(s) of a scene with object(s), a heatmap including pixels. Each pixel is associated with a respective probability of being a keypoint. The computing device can generate, using the machine learning network based on the image(s), a dense descriptor tensor including descriptor values. Each descriptor value is associated with a respective one or more pixels of the pixels. The computing device can determine, from the pixels, selected keypoints and can interpolate descriptor values associated with the selected keypoints to determine interpolated descriptor values. The computing device can determine a respective binary number for each interpolated descriptor value. The computing device can output a selected keypoint result based on the respective binary number for each interpolated descriptor value.

### FIELD

The present disclosure generally relates to image processing. For example, aspects of the present disclosure relate to integer-based sampling of binary descriptors from quantized tensors.

### BACKGROUND

Many devices and systems can obtain data (e.g., image frames or video), such as from their environment (e.g., including a scene). In some cases, the data can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. In some examples, convolutional neural networks are able to identify keypoints (e.g., which may be associated with one or more objects) in an image, and to describe each of the keypoints with a small vector (e.g., a descriptor).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for image processing, including integer-based sampling of binary descriptors from quantized tensors. In some aspects, an apparatus for image processing is provided. The apparatus includes at least one memory and at least one processor coupled to the at least one memory and configured to: generate, using a machine learning network based on one or more images of a scene including one or more objects, a heatmap including a plurality of pixels, wherein each pixel of the plurality of pixels is associated with a respective probability of being a keypoint; generate, using the machine learning network based on the one or more images, a dense descriptor tensor including a plurality of descriptor values, wherein each descriptor value of the plurality of descriptor values is associated with a respective one or more pixels of the plurality of pixels; determine, from the plurality of pixels, a plurality of selected keypoints; interpolate descriptor values of the plurality of descriptor values associated with the plurality of selected keypoints to determine a plurality of interpolated descriptor values; determine a respective binary number for each interpolated descriptor value of the plurality of interpolated descriptor values; and output a selected keypoint result based on the respective binary number for each interpolated descriptor value.

In some aspects, a method for image processing is provided. The method includes: generating, by a machine learning network of a device based on one or more images of a scene including one or more objects, a heatmap including a plurality of pixels, wherein each pixel of the plurality of pixels is associated with a respective probability of being a keypoint; generating, by the machine learning network based on the one or more images, a dense descriptor tensor including a plurality of descriptor values, wherein each descriptor value of the plurality of descriptor values is associated with a respective one or more pixels of the plurality of pixels; determining, from the plurality of pixels, a plurality of selected keypoints; interpolating descriptor values of the plurality of descriptor values associated with the plurality of selected keypoints to determine a plurality of interpolated descriptor values; determining a respective binary number for each interpolated descriptor value of the plurality of interpolated descriptor values; and outputting a selected keypoint result based on the respective binary number for each interpolated descriptor value.

In some aspects, a non-transitory computer-readable medium is provided having stored thereon instructions that, when executed by at least one processor, cause the at least one processor to: generate, using a machine learning network based on one or more images of a scene including one or more objects, a heatmap including a plurality of pixels, wherein each pixel of the plurality of pixels is associated with a respective probability of being a keypoint; generate, using the machine learning network based on the one or more images, a dense descriptor tensor including a plurality of descriptor values, wherein each descriptor value of the plurality of descriptor values is associated with a respective one or more pixels of the plurality of pixels; determine, from the plurality of pixels, a plurality of selected keypoints; interpolate descriptor values of the plurality of descriptor values associated with the plurality of selected keypoints to determine a plurality of interpolated descriptor values; determine a respective binary number for each interpolated descriptor value of the plurality of interpolated descriptor values; and output a selected keypoint result based on the respective binary number for each interpolated descriptor value.

In some aspects, an apparatus for image processing is provided. The apparatus includes: means for generating, based on one or more images of a scene including one or more objects, a heatmap including a plurality of pixels, wherein each pixel of the plurality of pixels is associated with a respective probability of being a keypoint; means for generating, based on the one or more images, a dense descriptor tensor including a plurality of descriptor values, wherein each descriptor value of the plurality of descriptor values is associated with a respective one or more pixels of the plurality of pixels; means for determining, from the plurality of pixels, a plurality of selected keypoints; means for interpolating descriptor values of the plurality of descriptor values associated with the plurality of selected keypoints to determine a plurality of interpolated descriptor values; means for determining a respective binary number for each interpolated descriptor value of the plurality of interpolated descriptor values; and means for outputting a selected keypoint result based on the respective binary number for each interpolated descriptor value.

In some aspects, one or more of the apparatuses described herein is, can be part of, or can include an extended reality device (e.g., a virtual reality (VR) device, an augmented reality (AR) device, or a mixed reality (MR) device), a mobile device (e.g., a mobile telephone or so-called “smart phone”, a tablet computer, or other type of mobile device), a smart or connected device (e.g., an Internet-of-Things (IoT) device), a wearable device, a vehicle (or a computing device, system, or component of a vehicle), a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example implementation of a system-on-a-chip (SoC), in accordance with some aspects of the disclosure.

FIG. 2A is a diagram illustrating an example of a fully connected neural network, in accordance with some aspects of the disclosure.

FIG. 2B is a diagram illustrating an example of a locally connected neural network, in accordance with some aspects of the disclosure.

FIG. 2C is a diagram illustrating an example of a convolutional neural network, in accordance with some aspects of the disclosure.

FIG. 3 is a block diagram illustrating an example of a deep learning network, in accordance with some aspects of the disclosure.

FIG. 4 is a block diagram illustrating an example of a convolutional neural network, in accordance with some aspects of the disclosure.

FIG. 5 is a diagram illustrating an example of a system for integer-based sampling of binary descriptors from quantized tensors, in accordance with some aspects of the disclosure.

FIG. 6 is a diagram illustrating an example of network output quantization, in accordance with some aspects of the disclosure.

FIG. 7 is a diagram illustrating an example of non-maximum suppression (NMS) based on a comparison of probabilities of neighboring pixels with a probability of a pixel, in accordance with some aspects of the disclosure.

FIG. 8 is a diagram illustrating an example of fast integer sampling to determine sub-pixel keypoints, in accordance with some aspects of the disclosure.

FIG. 9 is a flow diagram illustrating an example of a process for image processing, in accordance with some aspects of the disclosure.

FIG. 10 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As noted above, machine learning systems (e.g., deep neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

Image detection and description are fundamental tasks in computer vision that involve selecting a reduced amount of keypoints in an image, and describing each of the keypoints with a small vector, which is a descriptor. The identification of keypoints with their associated descriptors can be useful for many downstream tasks, such as image matching, object detection, camera pose re-localization, Structure-from-Motion (SfM), and Simultaneous Localization and Mapping (SLAM).

A key part of the process for identifying keypoints and their associated descriptors is to select a small set of heatmap locations from a heatmap of an image, and to sample the dense tensor of descriptors at these locations. This process involves thresholding regions of the heatmap whose probability value (e.g., probability of being a keypoint) is smaller than a certain threshold, removing pixels (e.g., based on performing non-maximum suppression) that do not have a maximal value (e.g., highest probability of being a keypoint) amongst pixels within in the neighborhood to determine potential keypoints, selecting a number (e.g., N number) of keypoints with the highest probabilities of being keypoints, clustering contiguous pixels that have the same probability values of each other, using the selected keypoints to bilinearly interpolate the dense tensor of descriptors, and applying a sign operator to convert the real-valued descriptors into binary values.

Currently, modern approaches, such as SuperPoint or A Lighter Keypoint and Descriptor Extraction Network (ALIKED), use a convolutional neural network (CNN) that produces a dense tensor of features (e.g., descriptor candidates) and a heatmap indicating the likelihood of each pixel to be a salient keypoint. It is fundamental that the execution of the process for identifying keypoints and their associated descriptors is fast and accurate. The common approach is to directly de-quantize the heatmap and the dense descriptors tensor. However, this de-quantization step consumes additional computational time and power.

As such, improved systems and techniques for identifying keypoints and their associated descriptors without performing de-quantiziation can be beneficial.

In one or more aspects of the present disclosure, systems, apparatuses, methods (also referred to as processes), and computer-readable media (collectively referred to herein as “systems and techniques”) are described herein that provide solutions for integer-based sampling of binary descriptors from quantized tensors.

Various aspects relate generally to image processing. Some aspects more specifically relate to systems and techniques that provide solutions that allow for the process of identifying keypoints and their associated descriptors to directly operate on integer arithmetic, without the need for de-quantization. Without performing de-quantiziation improves the power consumption and latency of the system.

In one or more examples, the systems and techniques can employ a machine learning network (e.g., a neural network) to detect and describe keypoints in an image. The machine learning network can produce a dense tensor of descriptors and a heatmap indicating the per-pixel probability of being a keypoint. In one or more examples, the weights and/or activations of the machine learning network can be quantized to a particular integer precision (e.g., integer four (int4), integer eight (int8), integer 16 (int16), etc.). In one or more examples, the implementation of the systems and techniques considers the quantization of the tensors coming from the machine learning network, and the binarization of the output results. As described herein, the systems and techniques can rely on integer arithmetic, which makes the entire process hardware friendly.

In one or more aspects, the systems and techniques provide a process for identifying keypoints and their associated descriptors. In one or more examples, the process can involve performing thresholding, where a threshold is transformed with a quantization transformation. In some examples, the process can also involve NMS, where a pixel that is a maximal candidate (e.g., has a highest probability of being a keypoint) can be identified by a Boolean mask. The probability of being a keypoint of the pixel can be compared with the probabilities of neighboring pixels. If no other neighboring pixels has a probability that is greater than the probability of the current pixel, the current pixel can be marked as maximal (e.g., determined to be a keypoint). In some examples, keypoints with the same values can be clustered together and converted to two-dimensional (2D) coordinates (e.g., by converting them into floats and then dividing by the third coordinate). In one or more examples, the sampling of a descriptor for each given keypoint in an image can be achieved by performing bilinear interpolation in locations of keypoints, scaled down onto a smaller resolution of the dense descriptor. Only needed tensors may be used to calculate the descriptor for the keypoint. In some examples, a binarization operation can be performed on the quantized descriptors (e.g., quantized to int8, etc.), using an unsigned integer threshold (e.g., an unsigned integer eight (uint8) threshold of 127). In one or more examples, a number height width channel (NHWC) tensor layout can be used such that neighboring cells over the x-axis are next to each other in memory, which can enable a faster memory read. In some examples, floating point values for keypoint coordinates can also also converted into integer format with a fixed grid resolution multiplier, applied to the keypoint coordinates.

In one or more aspects, during operation of a method for image processing, one or more image sensors of a device can obtain one or more images of a scene including one or more objects. A machine learning network can generate, based on the one or more images, a heatmap including a plurality of pixels. In one or more examples, each pixel of the plurality of pixels can be associated with a respective probability of being a keypoint. The machine learning network, based on the one or more images, can generate a dense descriptor tensor including a plurality of descriptor values. In one or more examples, each descriptor value of the plurality of descriptor values can be associated with a respective one or more pixels of the plurality of pixels.

One or more processors (e.g., of a thresholding engine) can determine whether the respective probability of each pixel of the plurality of pixels is greater than a threshold value. The one or more processors (e.g., of the thresholding engine) can assign a respective binary number (e.g., a one (1) or a zero (0)) to each pixel of the plurality of pixels based on the respective probability of each pixel of the plurality of pixels being less than or greater than the threshold value. The one or more processors (e.g., of the thresholding engine) can determine one or more pixels of the plurality of pixels is a potential keypoint based on determining the respective probability of the one or more pixels is greater than the threshold value.

One or more processors (e.g., of a non-maximum suppression engine, based on performing non-maximum suppression) can determine whether a respective probability of a plurality of associated neighboring pixels of each of the one or more pixels determined to be a potential keypoint is greater than the respective probability of the one or more pixels determined to be a potential keypoint. The one or more processors (e.g., of the non-maximum suppression engine) can determine at least one pixel of the one or more pixels determined to be a potential keypoint is a keypoint based on the respective probability of the at least one pixel being greater than the respective probabilities of the plurality of associated neighboring pixels. The one or more processors (e.g., of the non-maximum suppression engine) can determine a number (e.g., N number) of keypoints with the highest probabilities of the keypoints to determine a plurality of selected keypoints.

One or more processors (e.g., of a bilinear sampling engine) can bilinearly interpolate descriptor values of the plurality of descriptor values associated with the plurality of selected keypoints to determine a plurality of interpolated descriptor values. One or more processors (e.g., of a sign engine) can determine a respective binary number for each interpolated descriptor value of the plurality of interpolated descriptor values. The one or more processors (e.g., of the sign engine) can output a selected keypoint result based on the respective binary number for each interpolated descriptor value.

In one or more examples, a selected keypoint of the selected keypoints can include keypoint information. In some examples, the keypoint information can include location coordinates of the selected keypoint, the probability of the selected keypoint, and a binary number determined for a descriptor value associated with the selected keypoint. In one or more examples, the device can be a mobile computing device or a vehicle.

Particular aspects of the subject matter described in this disclosure can be implemented to realize one or more of the following potential advantages. For example, the systems and techniques can provide the benefit of allowing for each step of the process (e.g., for identifying keypoints and their associated descriptors) to directly operate using integer precision (e.g., using integer arithmetic) without the need for de-quantization and, as such, improving power consumption and latency.

Additional aspects of the present disclosure are described in more detail below.

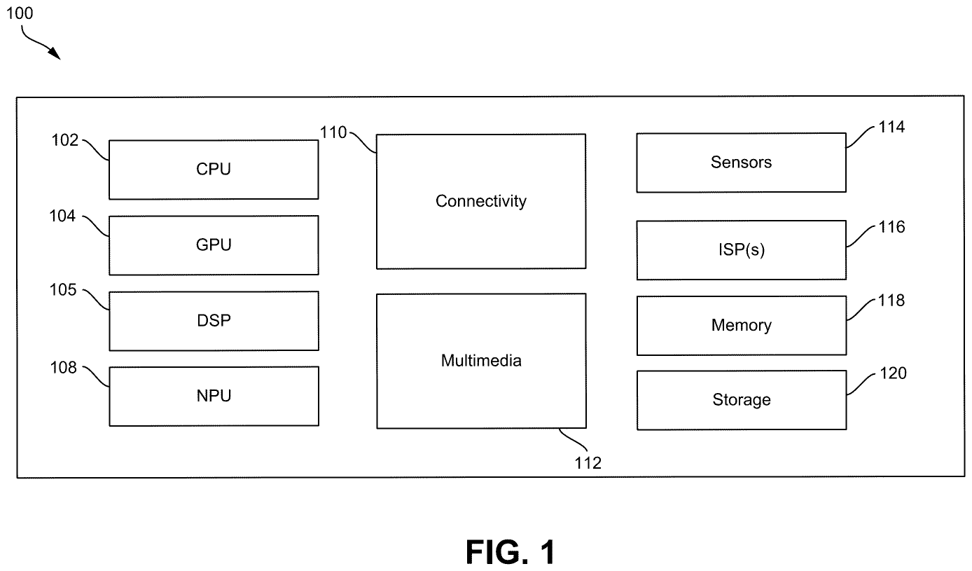

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 105, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 105, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 105, and/or GPU 104. The SOC 100 may also include one or more sensors 114, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform disparity estimation refinement for pairs of images (e.g., stereo image pairs, each including a left image and a right image). SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 105, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 105, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 105, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

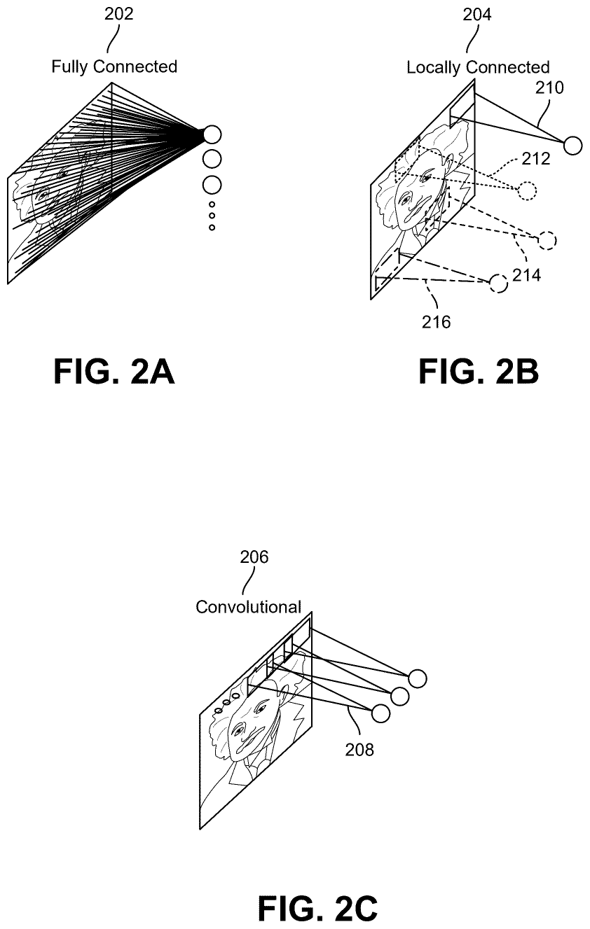

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

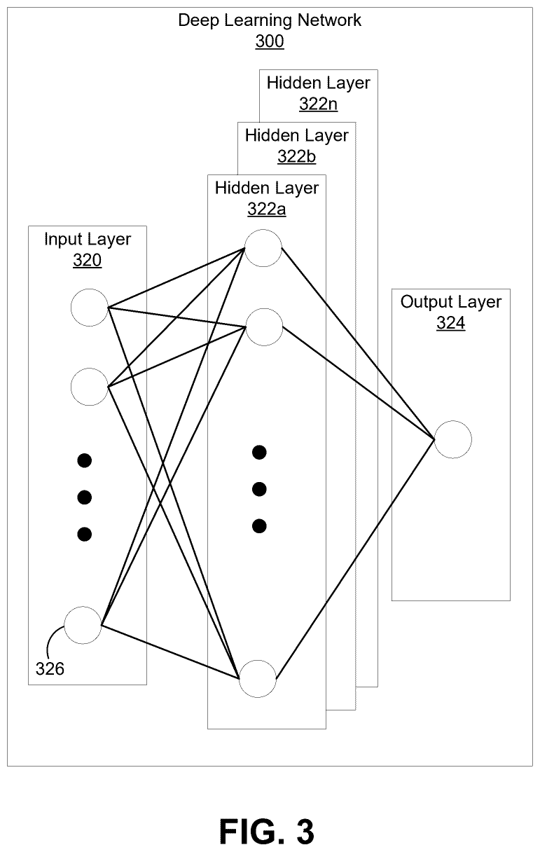

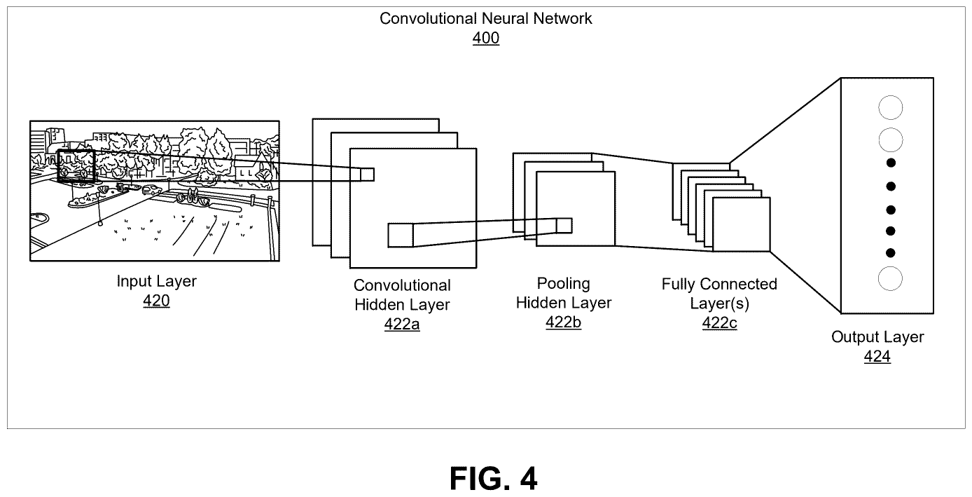

An example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure. An illustrative example of a deep learning network is described in greater depth with respect to the example block diagram of FIG. 3. An illustrative example of a convolutional neural network is described in greater depth with respect to the example block diagram of FIG. 4.

FIG. 3 is an illustrative example of a deep learning neural network 300 that can be used to perform object detection. An input layer 320 includes input data. In some examples, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some examples, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 300, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 300 is unable to determine low level features and thus cannot make an accurate determination of what the classification of the object might be. A loss function can be used to analyze error in the output. Any suitable loss function definition can be used. An example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 300 can include any suitable deep network. As described previously, an example of a neural network 300 includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some examples, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some examples, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

As previously mentioned, image detection and description are fundamental tasks in computer vision that involve selecting a reduced amount of keypoints in an image, and describing each of the keypoints with a small vector (e.g., a descriptor). The identification of keypoints with their associated descriptors can be useful for many downstream tasks including, but not limited to, image matching, object detection, camera pose re-localization, SfM, and SLAM.

A key part of the process for identifying keypoints and their associated descriptors is to select a small set of heatmap locations from a heatmap of an image, and to sample the dense tensor of descriptors at these locations. This process includes thresholding regions of the heatmap whose probability value (e.g., probability of being a keypoint) is smaller than a certain threshold, removing pixels (e.g., based on NMS) that do not have a maximal value (e.g., highest probability of being a keypoint) amongst pixels within in the neighborhood to determine potential keypoints, selecting a number (e.g., N number) of keypoints with the highest probabilities of being keypoints, clustering contiguous pixels that have the same probability values of each other, using the selected keypoints to bilinearly interpolate the dense tensor of descriptors, and applying a sign operator to convert the real-valued descriptors into binary values.

Existing modern approaches, such as SuperPoint and ALIKED, use a CNN that produces a dense tensor of features (e.g., descriptor candidates) and a heatmap indicating the likelihood of each pixel to be a salient keypoint. It is fundamental that the execution of the process for identifying keypoints and their associated descriptors is accurate and fast. The common existing approach is to directly de-quantize the heatmap and the dense descriptors tensor. This de-quantization step, however, consumes additional computational time and power. Therefore, improved systems and techniques for identifying keypoints and their associated descriptors without performing de-quantiziation can be useful.

In one or more aspects, the systems and techniques provide solutions for integer-based sampling of binary descriptors from quantized tensors. In one or more examples, the systems and techniques provide solutions that allow for the process of identifying keypoints and their associated descriptors to directly operate using integer precision (e.g., using integer arithmetic), without the need for de-quantization. Without performing de-quantiziation improves the power consumption and latency of the system.

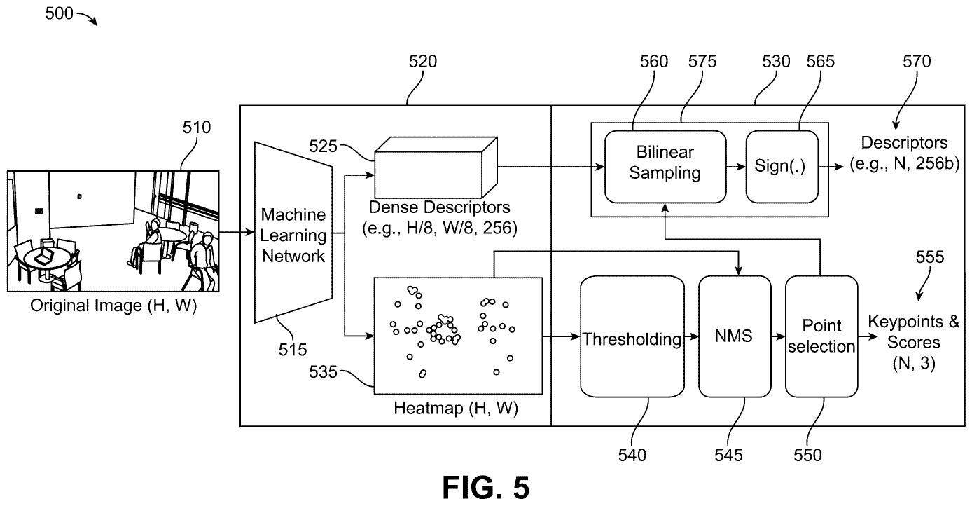

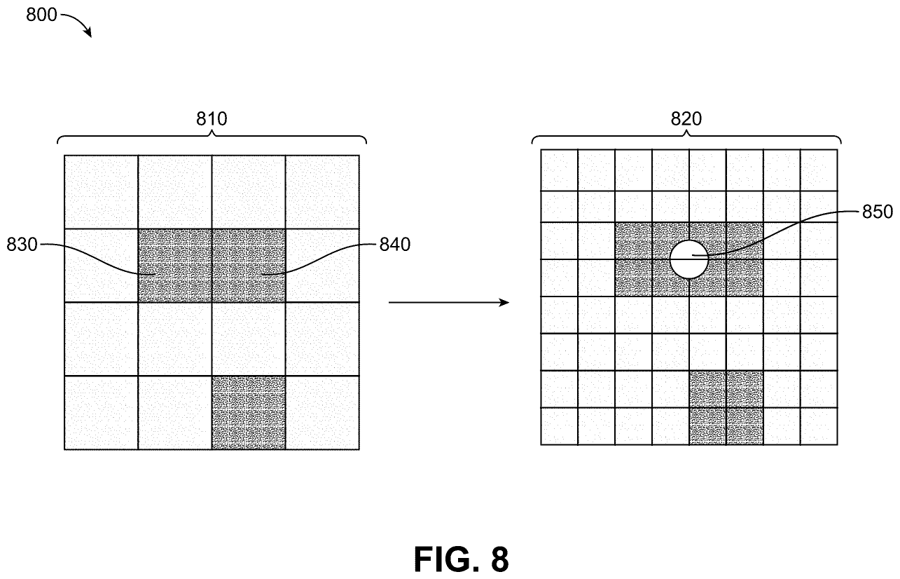

FIG. 5 shows an example system for identifying keypoints and their associated descriptors without performing de-quantiziation. In particular, FIG. 5 is a diagram illustrating an example of a system 500 for integer-based sampling of binary descriptors from quantized tensors. In FIG. 5, the system 500 is shown to include two portions, which are a first portion 520 and a second portion 530. The first portion 520 includes quantized operations using integer precision (e.g., based on values quantized as int4 values, int8 values, int16 values, etc.), and the second portion 530 includes binarization of the output results, also performed using integer precision. The first portion 520 of the system 500 is shown to include a machine learning network 515 (e.g., a neural network, such as a CNN). The second portion 530 of the system 500 is shown to include a thresholding engine 540, a NMS engine 545, a bilinear sampling engine 560, and a sign engine 565. In one or more examples, the bilinear sampling engine 560 and the sign engine 565 can together perform fast integer sampling 575, which is discussed in detail in the description of FIG. 8. The operations described herein with respect to FIG. 5 of obtaining probabilities (e.g., probabilities associated with a heatmap 535, where each pixel of the heatmap 535 can be associated with a respective probability of being a keypoint), thresholding performed by the thresholding engine 540, NMS performed by the NMS engine 545, bilinear sampling of descriptors performed by the bilinear sampling engine 560, and binarization of the descriptors performed by the sign engine 565 are performed using integer precision, which allows the system 500 to avoid the need for de-quantization and thus improves the power consumption and latency of the system 500.

During operation of the system 500 of FIG. 5, one or more image sensors of a device can obtain one or more images 510 (e.g., original image) of a scene including one or more objects. In one or more examples, the device can be a mobile computing device (e.g., a smart phone, smart glasses, a wearable device, or a laptop computer) or a vehicle. In one or more examples, each image 510 can have a height (H) and a width (W).

The machine learning network 515 can generate, based on the one or more images 510, a heatmap 535 including a plurality of pixels. In one or more examples, the heatmap 535 can have the height (H) and the width (W), similar to (or the same as) the resolution of each of the images 510. In one or more examples, each pixel of the plurality of pixels can be associated with a respective probability of being a keypoint. For example, a first pixel can have a first probability value indicating a probability that the first pixel is a keypoint, a second pixel can have a second probability value indicating a probability that the second pixel is a keypoint, and so on. The machine learning network 515, based on the one or more images 510, can generate a dense descriptor tensor 525 including a plurality of descriptor values. In one or more examples, the dense descriptor tensor 525 can be in the form of a matrix with a height (H/8), a width (W/8), and a length of 256. In one or more examples, each descriptor value of the plurality of descriptor values can be associated with a respective one or more pixels of the plurality of pixels. For instance, each descriptor can be associated with one pixel or multiple pixels.

In one or more examples, the machine learning network 515 can provide, similar to SuperPoint, outputs including the heatmap 535 where higher probability values correspond to points in the heatmap 535 that are considered more likely to be keypoints, and the dense descriptor tensor 525 which has a smaller resolution than (e.g., an eighth of the resolution of) the heatmap 525.

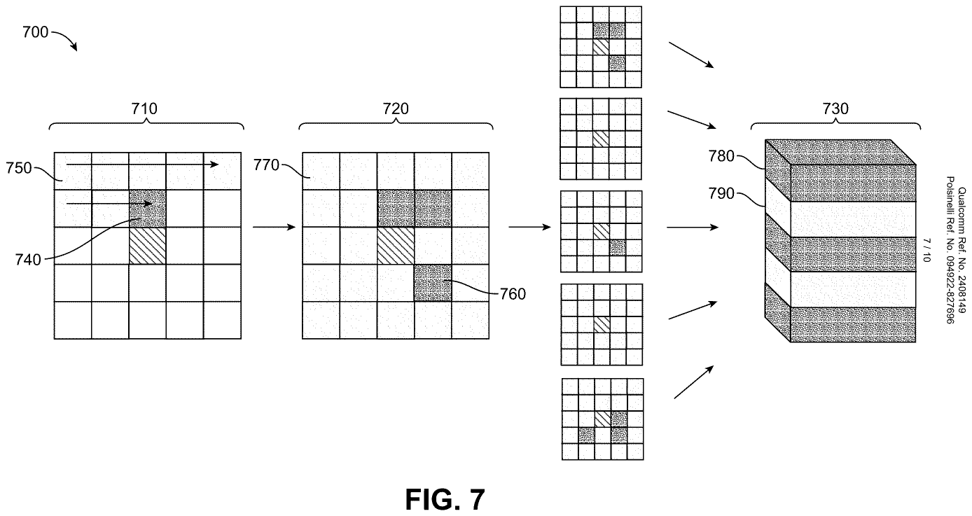

The goal of the sampling algorithm of the second portion 530 is to find the keypoints in the heatmap 535, and compute their respective descriptor values using the dense descriptor tensor 525. The weights and/or activations of the machine learning network 515 are quantized to a particular integer precision (e.g., integer four (int4), integer eight (int8), integer 16 (int16), etc.). However, the existing baseline algorithm (e.g., baseline algorithm 710 of FIG. 7 performed for NMS) required de-quantization of the heatmap 535 and the dense descriptor tensor 525 to perform sampling. In one or more examples, integer math (e.g., 8 bit integer math) is used to decrease the latency and power consumption of the sampling.

In one or more examples, a neural processing engine (NPE) application programming interface (API) can determine the quantization parameters that map for each tensor the output of the machine learning network 515 from the integer (e.g., int8, etc.) representation (of the first portion 520) to the floating-point domain (of the second portion 530). These parameters can include a scaling factor and a one-dimensional translation. Under this definition, thresholding (e.g., by the thresholding engine 540) in the integer domain (e.g., the int8 space) is exactly equivalent to doing so in the real (floating point) space. To allow the system 500 to operate in the integer domain, the threshold can be transformed with the quantization transformation. Network quantization reduces the precision of the weights and activations in a neural network, leading to significant reductions in the model size and computational requirements.

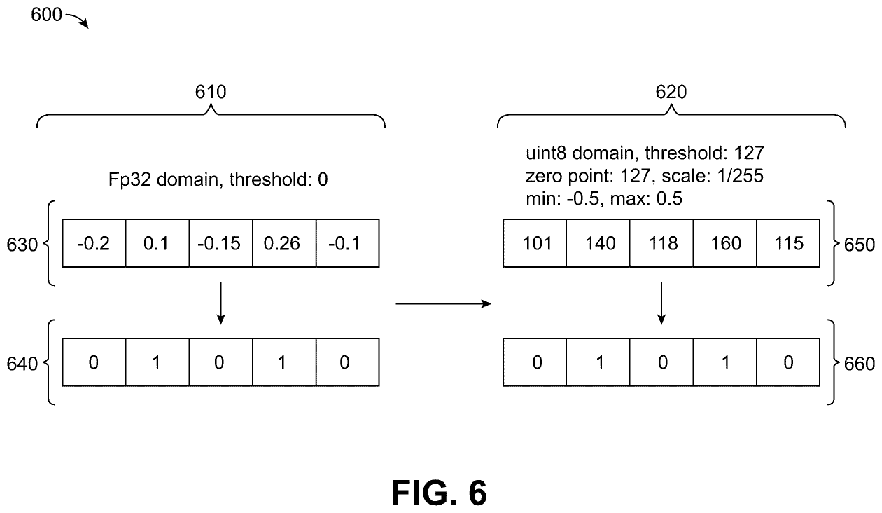

FIG. 6 shows an example network output quantization. In particular, FIG. 6 is a diagram illustrating an example 600 of network output quantization. FIG. 6 shows a plurality of respective probability values 630 (of being a keypoint) for a plurality of pixels (e.g., five pixels) of a heatmap in a floating-point 32 (Fp32) domain 610 and a plurality of respective probability values 650 (of being a keypoint) for the same plurality of pixels in an unsigned integer eight (uint8) domain 620. While the Fp32 and uint8 domains are used as illustrative examples in FIG. 6, other floating point values and integer values can be used. As shown in FIG. 6, the plurality of respective probability values 630 (of being a keypoint) for the plurality of pixels (e.g., five pixels) in Fp 32 domain 610 has been transformed to uint8 domain 620.

After the machine learning network 515 (of the first portion 520 of the system 500) has generated the heatmap 535 and the dense descriptor tensor 525, the process can proceed to the sampling algorithm (of the second portion 530 of the system 500). For the thresholding, one or more processors (e.g., of the thresholding engine 540) can determine whether the respective probability of each pixel of the plurality of pixels is greater than a threshold value (e.g., zero or 127). The one or more processors (e.g., of the thresholding engine 540) can assign a respective binary number (e.g., a one (1) or a zero (0)) to each pixel of the plurality of pixels based on the respective probability of each pixel of the plurality of pixels being less than or greater than the threshold value. For the thresholding, it is still possible to directly sample binary descriptors in integer data types, but it is necessary to fix the scale and compute the threshold correctly.

Referring back to FIG. 6, in the Fp 32 domain 610, each probability value of the plurality of respective probability values 630 (of being a keypoint) for the plurality of pixels is shown to be assigned a binary number of a one or zero (e.g., as shown in the plurality of binary probabilities values 640) based on the threshold value of zero. For example, if the probability value 630 (e.g., 0.1) is greater than the threshold value of zero, a binary number of one (1) is assigned to that probability value. For another example, if the probability value 630 (e.g., −0.2) is less than the threshold value of zero, a binary number of zero (0) is assigned to that probability value.

In FIG. 6, in the uint8 domain 620, each probability value of the plurality of respective probability values 650 (of being a keypoint) for the plurality of pixels is shown to be assigned a binary number of a one or zero (e.g., as shown in the plurality of binary probabilities values 660) based on the threshold value of 127. For example, if the probability value 650 (e.g., 140) is greater than the threshold value of 127, a binary number of one (1) is assigned to that probability value. For another example, if the probability value 650 (e.g., 101) is less than the threshold value of 127, a binary number of zero (0) is assigned to that probability value.

The one or more processors (e.g., of the thresholding engine 540) can determine one or more pixels of the plurality of pixels is a potential keypoint based on determining the respective probability of the one or more pixels is greater than the threshold value. In one or more examples, the one or more processors (e.g., of the thresholding engine 540) can determine that the pixels of the plurality of pixels with probability values equal to a binary number of one (1) are potential keypoints.

One or more processors (e.g., of the NMS engine 545) can perform a highly optimized implementation of NMS that is able to operate in integer precision and is also vectorization-friendly. For the operation of NMS, a Boolean mask can be defined that can indicate whether a pixel is a maximal candidate (e.g., a potential keypoint). The Boolean mask can be initialized by thresholding the heatmap 535 with the quantized detection threshold. For each pixel in the image, if the pixel is a maximal candidate (e.g., a potential keypoint), in a single Eigen operation (e.g., that is suitable to be compiler-optimized), the probability value of that pixel can be compared with the probability values of its neighboring pixels. If no neighboring pixels has a probability value that is greater than the probability value of the current pixel (e.g., the potential keypoint), the current pixel can be marked as maximal (e.g., a keypoint).

One or more processors (e.g., of the NMS engine 545, based on performing NMS) can determine whether a respective probability of a plurality of associated neighboring pixels of each of the one or more pixels determined to be a potential keypoint is greater than the respective probability of the one or more pixels determined to be a potential keypoint. The one or more processors (e.g., of the NMS engine 545) can determine at least one pixel of the one or more pixels determined to be a potential keypoint is indeed a keypoint, based on the respective probability of the at least one pixel being greater than the respective probabilities of the plurality of associated neighboring pixels.

FIG. 7 shows an example of NMS. In particular, FIG. 7 is a diagram illustrating an example of NMS 700 based on a comparison of probabilities of neighboring pixels with a probability of a pixel. In FIG. 7, two different approaches for NMS are shown. The two approaches include a baseline approach 710 and a disclosed approach 720.

For the baseline approach 710, a matrix (e.g., a four by four matrix) of neighboring pixels (to each pixel of the plurality of pixels in the image) is shown. In one or more examples, the matrix may be of a different size (e.g., a five by five matrix) than the four by four matrix shown in FIG. 7. In some examples, the pixel may be located at the center of the matrix. During operation of NMS for the baseline approach 710, one or more processors can determine whether any of the neighboring pixels has a higher probability than the pixel. As such, for the baseline approach 710, NMS operates in an iterative way with one branch per pixel. FIG. 7 shows pixels 750 that each have a probability less than the probability of the pixel, and shows a pixel 740 that has a probability greater than the probability of the pixel. Since there is a pixel 740 that has a probability greater than the probability of the pixel, the pixel is not determined to be a keypoint.

For the disclosed approach 720, a matrix (e.g., a four by four matrix) of neighboring pixels (to a pixel determined to be a potential keypoint) is shown. In one or more examples, the matrix may be of a different size (e.g., a five by five matrix) than the four by four matrix shown in FIG. 7. In some examples, the pixel determined to be a potential keypoint may be located at the center of the matrix. During operation of NMS for the disclosed approach 720, one or more processors (e.g., of the NMS engine 545) can determine whether any of the neighboring pixels has a higher probability than the pixel determined to be a potential keypoint. As such, for the disclosed approach 720, NMS operates in an iterative way with one branch per candidate (e.g., per potential keypoint). FIG. 7 shows pixels 770 that each have a probability less than the probability of the pixel determined to be a potential keypoint, and shows pixels 760 that each have a probability greater than the probability of the pixel determined to be a potential keypoint. Since there are pixels 760 that each have a probability greater than the probability of the pixel determined to be a potential keypoint, the pixel determined to be a potential keypoint is not determined to actually be a keypoint.

FIG. 7 also shows a hexagonal implementation 730 that may be employed for high speed processing by hexagonal processors, which can process multiple different instructions simultaneously. For the hexagonal implementation 730, a plurality of matrices (e.g., including the matrix shown in the disclosed approach 720) are shown to be stacked on top of each other in a three-dimensional (3D) format. This hexagonal implementation 3D allows for a hexagonal processor to be able to sample multiple regions at the same time and, as such, be able to sample multiple candidates (e.g., potential keypoints) at the same time. In FIG. 7, the hexagonal implementation 730 is shown to include matrices 780 (e.g., three matrices) that have at least one neighboring pixel with a greater probability than the probability of the pixel determined to be a potential keypoint, and to include matrices 790 (e.g., two matrices) that do not have at least one neighboring pixel with a greater probability than the probability of the pixel determined to be a potential keypoint.

After performing the disclosed approach 720, although it is now evident that no neighboring pixels have a higher probability than the probabilities of the pixels determined to be potential keypoints, some of the pixels determined to be potential keypoints may have the same probabilities as each other, which can occur rather frequently when operating with quantized tensors. When pixels determined to be potential keypoints have the same probabilities as each other and these pixels are located nearby each other, one or more processors (e.g., of the NMS engine 545) can cluster these pixels together into a group to form a single keypoint. In one or more examples, this operation can be efficiently performed by using a homogeneous coordinate that acts as a counter.

The one or more processors (e.g., of the NMS engine 545) can then determine (e.g., during point selection 550) a number (e.g., N number) of keypoints with the highest probabilities of the keypoints to determine a plurality of selected keypoints. In one or more examples, the keypoints can be converted to two-dimensional (2D) coordinates by converting them into floats and then dividing by the third coordinate.

The sampling of a descriptor for each given selected keypoint in an image can be achieved by performing bilinear interpolation in locations of the selected keypoints, scaled down onto the smaller resolution of the dense descriptor tensor 525. One or more processors (e.g., of the bilinear sampling engine 560) can bilinearly interpolate descriptor values of the plurality of descriptor values associated with the plurality of selected keypoints to determine a plurality of interpolated descriptor values.

Since each of the descriptor values in the dense descriptor tensor 525 may not be needed in the process of calculating the descriptor values for each selected keypoint, it is undesirable to perform dequantization on the whole tensor since its size may be quite large. As such, the quantization settings of the model output can be tuned to ensure that de-quantization is not needed anymore. By doing so, the same binary result can be ensured without needing a costly de-quantization operation and speeding up the sampling algorithm.

One or more processors (e.g., of the sign engine 565) can determine a respective binary number for each interpolated descriptor value of the plurality of interpolated descriptor values. The one or more processors (e.g., of the sign engine) can output a selected keypoint result (e.g., descriptors 570) based on the respective binary number for each interpolated descriptor value. Since a hashing algorithm computes the binary descriptor values by comparing it to a calibrated threshold, by using a zero threshold and forcing symmetric quantization of the model, a binarization operation can be performed using integer precision (e.g., performed on quantized int8 descriptors, such as by using an uint8 threshold of 127, which maps exactly to zero in float domain since the quantization is symmetric).

In one or more examples, a selected keypoint of the selected keypoints can include keypoint information, including keypoints and scores 555 (N, 3) and descriptors 570 (N, 256b). In some examples, the keypoint information can include location coordinates (X, Y) of the selected keypoint, the probability (e.g., probability value) of the selected keypoint, and a binary number (e.g., a 256 digit binary number) determined for a descriptor value associated with the selected keypoint.

In one or more examples, the bilinear sampling engine 560 and the sign engine 565 can together perform fast integer sampling 575. Fast integer sampling 575 allows for determining sub-pixel keypoints.

FIG. 8 shows a fast integer sampling example. In particular, FIG. 8 is a diagram illustrating an example of fast integer sampling 800 to determine sub-pixel keypoints. FIG. 8 shows neighboring pixels 830, 840 (e.g., which are adjacent to each other) in a matrix 810 (e.g., a four by four matrix) that each have a probability greater than the probability of a pixel determined to be a potential keypoint. When adjacent pixels 830, 840 within a matrix (e.g., matrix 810) of pixels have the same probability values as each other, a keypoint 850 (e.g., as shown in matrix 820) can be placed in the center of the adjacent pixels 830, 840 and the resolution of the matrix 810 can be increased (e.g., by a factor of two) to a higher resolution (e.g., as shown in matrix 820) in order to determine sub-pixel keypoints. By virtually increasing the sampling grid, sub-pixel keypoints can be determined.

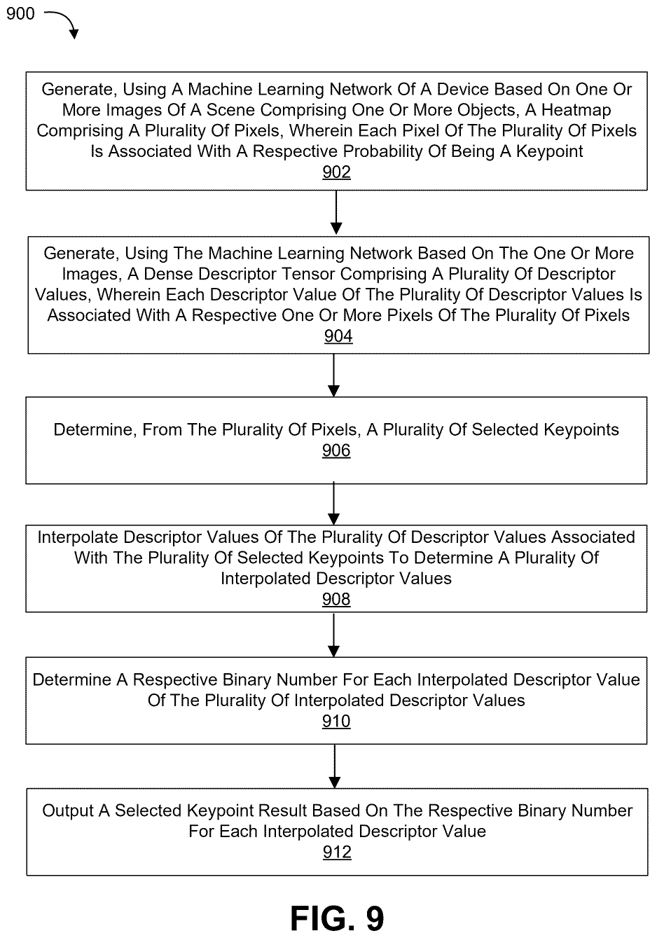

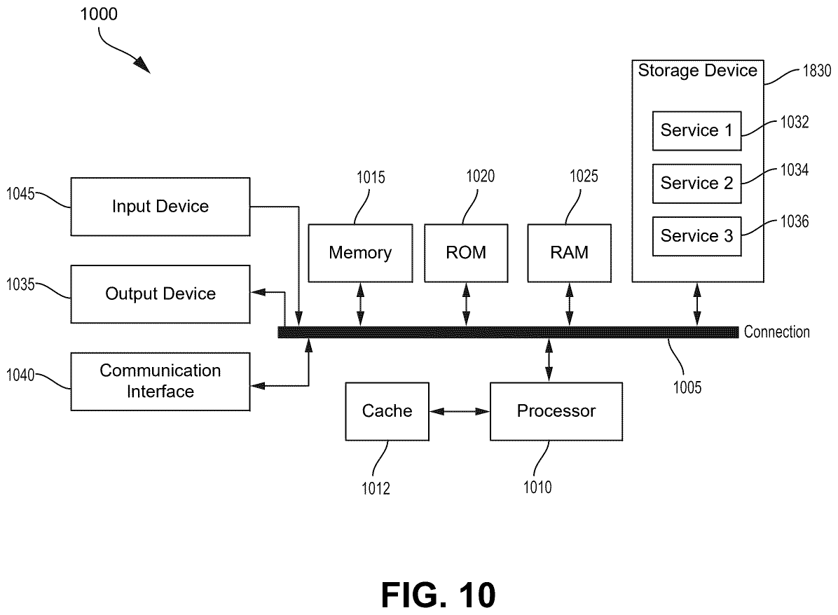

FIG. 9 is a flow chart illustrating an example of a process 900 for integer-based sampling of binary descriptors from quantized tensors. The process 900 can be performed by a computing device (e.g., a computing device or computing system 1000 of FIG. 10) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 900 may be implemented as software components that are executed and run on one or more processors (e.g., processor 1010 of FIG. 10, or other processor(s)). Further, the transmission and reception of signals by the computing device in the process 900 may be enabled, for example, by one or more antennas and/or one or more transceivers (e.g., wireless transceiver(s)).

At block 902, the computing device (or component thereof) can generate, using a machine learning network (e.g., the machine learning network 515 of FIG. 5) based on one or more images of a scene (e.g., the image 510) including one or more objects, a heatmap (e.g., the heatmap 535) including a plurality of pixels. In some cases, the machine learning network 515 can be part of the computing device or can be coupled to or in communication with (e.g., over a wired or wireless connection) the computing device. Each pixel of the plurality of pixels is associated with a respective probability of being a keypoint (e.g., a first pixel has a first probability value indicating a probability that the first pixel is a keypoint, a second pixel has a second probability value indicating a probability that the second pixel is a keypoint, and so on). In some aspects, the computing device (or component thereof) can obtain, from one or more image sensors, the one or more images of the scene including the one or more objects. In some cases, the one or more image sensors can be part of the computing device or can be coupled to or in communication with (e.g., over a wired or wireless connection) the computing device.

At block 904, the computing device (or component thereof) can generate, using the machine learning network based on the one or more images, a dense descriptor tensor (e.g., the dense descriptor tensor 525 of FIG. 5) including a plurality of descriptor values. Each descriptor value of the plurality of descriptor values is associated with a respective one or more pixels of the plurality of pixels (e.g., each descriptor value can be associated with one pixel or multiple pixels of the plurality of pixels).

At block 906, the computing device (or component thereof) can determine (e.g., using the thresholding engine 540), from the plurality of pixels, a plurality of selected keypoints. In some aspects, a selected keypoint of the plurality of selected keypoints includes keypoint information including location coordinates of the selected keypoint, a probability of the selected keypoint, and a binary number determined for a descriptor associated with the selected keypoint.

In some cases, to determine the plurality of selected keypoints, the computing device (or component thereof) can determine whether the respective probability of each pixel of the plurality of pixels is greater than a threshold value. The computing device (or component thereof) can determine one or more pixels of the plurality of pixels is a potential keypoint based on determining the respective probability of the one or more pixels is greater than the threshold value. In some cases, the computing device (or component thereof) can assign a respective probability binary number to each pixel of the plurality of pixels based on the respective probability of each pixel of the plurality of pixels being less than or greater than the threshold value.

In some aspects, the computing device (or component thereof) can determine whether the respective probabilities of the plurality of associated neighboring pixels of each pixel of the one or more pixels determined to be a potential keypoint is greater than the respective probability of each pixel of the one or more pixels determined to be a potential keypoint. The computing device (or component thereof) can determine at least one pixel of the one or more pixels determined to be a potential keypoint is a keypoint based on the respective probability of the at least one pixel being greater than respective probabilities of a plurality of associated neighboring pixels. In some aspects, the computing device (or component thereof) can determine at least one pixel of the one or more pixels determined to be a potential keypoint is a keypoint based on non-maximum suppression (NMS) (e.g., using the NMS engine 545 of FIG. 5). The computing device (or component thereof) can determine a number of keypoints with highest probabilities among determined keypoints to determine the plurality of selected keypoints. In some aspects, the computing device (or component thereof) can determine the number of keypoints with the highest probabilities among the determined keypoints to determine the plurality of selected keypoints based on NMS (e.g., using the NMS engine 545 of FIG. 5).

At block 908, the computing device (or component thereof) can interpolate (e.g., using the bilinear sampling engine 560) descriptor values of the plurality of descriptor values associated with the plurality of selected keypoints to determine a plurality of interpolated descriptor values.

At block 910, the computing device (or component thereof) can determine (e.g., using the sign engine 565) a respective binary number for each interpolated descriptor value of the plurality of interpolated descriptor values. In some aspects, to interpolate the descriptor values, the computing device (or component thereof) can bilinearly interpolate the descriptor values.

At block 912, the computing device (or component thereof) can output a selected keypoint result based on the respective binary number for each interpolated descriptor value.

In some cases, the computing device of process 900 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 900 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed for integer-based sampling of binary descriptors from quantized tensors. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LiDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the aspects disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: generate, using a machine learning network based on one or more images of a scene comprising one or more objects, a heatmap comprising a plurality of pixels, wherein each pixel of the plurality of pixels is associated with a respective probability of being a keypoint; generate, using the machine learning network based on the one or more images, a dense descriptor tensor comprising a plurality of descriptor values, wherein each descriptor value of the plurality of descriptor values is associated with a respective one or more pixels of the plurality of pixels; determine, from the plurality of pixels, a plurality of selected keypoints; interpolate descriptor values of the plurality of descriptor values associated with the plurality of selected keypoints to determine a plurality of interpolated descriptor values; determine a respective binary number for each interpolated descriptor value of the plurality of interpolated descriptor values; and output a selected keypoint result based on the respective binary number for each interpolated descriptor value.

Aspect 2. The apparatus of Aspect 1, wherein, to determine the plurality of selected keypoints, the at least one processor is configured to: determine one or more pixels of the plurality of pixels is a potential keypoint based on determining the respective probability of the one or more pixels is greater than a threshold value; determine at least one pixel of the one or more pixels determined to be a potential keypoint is a keypoint based on the respective probability of the at least one pixel being greater than respective probabilities of a plurality of associated neighboring pixels; and determine a number of keypoints with highest probabilities among determined keypoints to determine the plurality of selected keypoints.

Aspect 3. The apparatus of Aspect 2, wherein the at least one processor is configured to determine whether the respective probability of each pixel of the plurality of pixels is greater than the threshold value.

Aspect 4. The apparatus of any of Aspects 2 or 3, wherein the at least one processor is configured to assign a respective probability binary number to each pixel of the plurality of pixels based on the respective probability of each pixel of the plurality of pixels being less than or greater than the threshold value.

Aspect 5. The apparatus of any of Aspects 2 to 4, wherein the at least one processor is configured to determine whether the respective probabilities of the plurality of associated neighboring pixels of each pixel of the one or more pixels determined to be a potential keypoint is greater than the respective probability of each pixel of the one or more pixels determined to be a potential keypoint.

Aspect 6. The apparatus of any of Aspects 2 to 5, wherein the at least one processor is configured to determine at least one pixel of the one or more pixels determined to be a potential keypoint is a keypoint based on non-maximum suppression (NMS).

Aspect 7. The apparatus of any of Aspects 2 to 6, wherein the at least one processor is configured to determine the number of keypoints with the highest probabilities among the determined keypoints to determine the plurality of selected keypoints based on non-maximum suppression (NMS).

Aspect 8. The apparatus of any of Aspects 1 to 7, wherein a selected keypoint of the plurality of selected keypoints comprises keypoint information comprising location coordinates of the selected keypoint, a probability of the selected keypoint, and a binary number determined for a descriptor associated with the selected keypoint.

Aspect 9. The apparatus of any of Aspects 1 to 8, wherein, to interpolate the descriptor values, the at least one processor is configured to bilinearly interpolate the descriptor values.

Aspect 10. The apparatus of any of Aspects 1 to 9, wherein the at least one processor is configured to obtain, from one or more image sensors, the one or more images of the scene comprising the one or more objects.

Aspect 11. The apparatus of any of Aspects 1 to 10, wherein the apparatus is a mobile computing device or a vehicle.

Aspect 12. A method for image processing, the method comprising: generating, by a machine learning network of a device based on one or more images of a scene comprising one or more objects, a heatmap comprising a plurality of pixels, wherein each pixel of the plurality of pixels is associated with a respective probability of being a keypoint; generating, by the machine learning network based on the one or more images, a dense descriptor tensor comprising a plurality of descriptor values, wherein each descriptor value of the plurality of descriptor values is associated with a respective one or more pixels of the plurality of pixels; determining, from the plurality of pixels, a plurality of selected keypoints; interpolating descriptor values of the plurality of descriptor values associated with the plurality of selected keypoints to determine a plurality of interpolated descriptor values; determining a respective binary number for each interpolated descriptor value of the plurality of interpolated descriptor values; and outputting a selected keypoint result based on the respective binary number for each interpolated descriptor value.

Aspect 13. The method of Aspect 12, wherein determining the plurality of selected keypoints comprises: determining one or more pixels of the plurality of pixels is a potential keypoint based on determining the respective probability of the one or more pixels is greater than a threshold value; determining at least one pixel of the one or more pixels determined to be a potential keypoint is a keypoint based on the respective probability of the at least one pixel being greater than respective probabilities of a plurality of associated neighboring pixels; and determining a number of keypoints with highest probabilities among determined keypoints to determine the plurality of selected keypoints.

Aspect 14. The method of Aspect 13, further comprising determining whether the respective probability of each pixel of the plurality of pixels is greater than the threshold value.

Aspect 15. The method of any of Aspects 13 or 14, further comprising assigning a respective probability binary number to each pixel of the plurality of pixels based on the respective probability of each pixel of the plurality of pixels being less than or greater than the threshold value.

Aspect 16. The method of any of Aspects 13 to 15, further comprising determining whether the respective probabilities of the plurality of associated neighboring pixels of each pixel of the one or more pixels determined to be a potential keypoint is greater than the respective probability of each pixel of the one or more pixels determined to be a potential keypoint.

Aspect 17. The method of any of Aspects 13 to 16, wherein determining at least one pixel of the one or more pixels determined to be a potential keypoint is a keypoint is based on non-maximum suppression (NMS).

Aspect 18. The method of any of Aspects 13 to 17, wherein determining the number of keypoints with the highest probabilities among the determined keypoints to determine the plurality of selected keypoints is based on non-maximum suppression (NMS).

Aspect 19. The method of any of Aspects 12 to 18, wherein a selected keypoint of the plurality of selected keypoints comprises keypoint information comprising location coordinates of the selected keypoint, a probability of the selected keypoint, and a binary number determined for a descriptor associated with the selected keypoint.

Aspect 20. The method of any of Aspects 12 to 19, wherein interpolating the descriptor values comprises bilinearly interpolating the descriptor values.

Aspect 21. The method of any of Aspects 12 to 20, further comprising obtaining, by one or more image sensors of the device, the one or more images of the scene comprising the one or more objects.

Aspect 22. The method of any of Aspects 12 to 21, wherein the device is a mobile computing device or a vehicle.

Aspect 23. A non-transitory computer-readable medium having stored thereon instructions that, when executed by at least one processor, cause the at least one processor to perform operations according to any of Aspects 12 to 22.

Aspect 24. An apparatus for image processing, the apparatus including one or more means for performing operations according to any of Aspects 12 to 22.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
generate, using a machine learning network based on one or more images of a scene comprising one or more objects, a heatmap comprising a plurality of pixels, wherein each pixel of the plurality of pixels is associated with a respective probability of being a keypoint;
generate, using the machine learning network based on the one or more images, a dense descriptor tensor comprising a plurality of descriptor values, wherein each descriptor value of the plurality of descriptor values is associated with a respective one or more pixels of the plurality of pixels;
determine, from the plurality of pixels, a plurality of selected keypoints;
interpolate descriptor values of the plurality of descriptor values associated with the plurality of selected keypoints to determine a plurality of interpolated descriptor values;
determine a respective binary number for each interpolated descriptor value of the plurality of interpolated descriptor values; and
output a selected keypoint result based on the respective binary number for each interpolated descriptor value.

2. The apparatus of claim 1, wherein, to determine the plurality of selected keypoints, the at least one processor is configured to:
determine one or more pixels of the plurality of pixels is a potential keypoint based on determining the respective probability of the one or more pixels is greater than a threshold value;
determine at least one pixel of the one or more pixels determined to be a potential keypoint is a keypoint based on the respective probability of the at least one pixel being greater than respective probabilities of a plurality of associated neighboring pixels; and
determine a number of keypoints with highest probabilities among determined keypoints to determine the plurality of selected keypoints.

3. The apparatus of claim 2, wherein the at least one processor is configured to determine whether the respective probability of each pixel of the plurality of pixels is greater than the threshold value.

4. The apparatus of claim 2, wherein the at least one processor is configured to assign a respective probability binary number to each pixel of the plurality of pixels based on the respective probability of each pixel of the plurality of pixels being less than or greater than the threshold value.

5. The apparatus of claim 2, wherein the at least one processor is configured to determine whether the respective probabilities of the plurality of associated neighboring pixels of each pixel of the one or more pixels determined to be a potential keypoint is greater than the respective probability of each pixel of the one or more pixels determined to be a potential keypoint.

6. The apparatus of claim 2, wherein the at least one processor is configured to determine at least one pixel of the one or more pixels determined to be a potential keypoint is a keypoint based on non-maximum suppression (NMS).

7. The apparatus of claim 2, wherein the at least one processor is configured to determine the number of keypoints with the highest probabilities among the determined keypoints to determine the plurality of selected keypoints based on non-maximum suppression (NMS).

8. The apparatus of claim 1, wherein a selected keypoint of the plurality of selected keypoints comprises keypoint information comprising location coordinates of the selected keypoint, a probability of the selected keypoint, and a binary number determined for a descriptor associated with the selected keypoint.

9. The apparatus of claim 1, wherein, to interpolate the descriptor values, the at least one processor is configured to bilinearly interpolate the descriptor values.

10. The apparatus of claim 1, wherein the at least one processor is configured to obtain, from one or more image sensors, the one or more images of the scene comprising the one or more objects.

11. A method for image processing, the method comprising:
generating, by a machine learning network of a device based on one or more images of a scene comprising one or more objects, a heatmap comprising a plurality of pixels, wherein each pixel of the plurality of pixels is associated with a respective probability of being a keypoint;
generating, by the machine learning network based on the one or more images, a dense descriptor tensor comprising a plurality of descriptor values, wherein each descriptor value of the plurality of descriptor values is associated with a respective one or more pixels of the plurality of pixels;
determining, from the plurality of pixels, a plurality of selected keypoints;
interpolating descriptor values of the plurality of descriptor values associated with the plurality of selected keypoints to determine a plurality of interpolated descriptor values;
determining a respective binary number for each interpolated descriptor value of the plurality of interpolated descriptor values; and
outputting a selected keypoint result based on the respective binary number for each interpolated descriptor value.

12. The method of claim 11, wherein determining the plurality of selected keypoints comprises:
determining one or more pixels of the plurality of pixels is a potential keypoint based on determining the respective probability of the one or more pixels is greater than a threshold value;
determining at least one pixel of the one or more pixels determined to be a potential keypoint is a keypoint based on the respective probability of the at least one pixel being greater than respective probabilities of a plurality of associated neighboring pixels; and
determining a number of keypoints with highest probabilities among determined keypoints to determine the plurality of selected keypoints.

13. The method of claim 12, further comprising determining whether the respective probability of each pixel of the plurality of pixels is greater than the threshold value.

14. The method of claim 12, further comprising assigning a respective probability binary number to each pixel of the plurality of pixels based on the respective probability of each pixel of the plurality of pixels being less than or greater than the threshold value.

15. The method of claim 12, further comprising determining whether the respective probabilities of the plurality of associated neighboring pixels of each pixel of the one or more pixels determined to be a potential keypoint is greater than the respective probability of each pixel of the one or more pixels determined to be a potential keypoint.

16. The method of claim 12, wherein determining at least one pixel of the one or more pixels determined to be a potential keypoint is a keypoint is based on non-maximum suppression (NMS).

17. The method of claim 12, wherein determining the number of keypoints with the highest probabilities among the determined keypoints to determine the plurality of selected keypoints is based on non-maximum suppression (NMS).

18. The method of claim 11, wherein a selected keypoint of the plurality of selected keypoints comprises keypoint information comprising location coordinates of the selected keypoint, a probability of the selected keypoint, and a binary number determined for a descriptor associated with the selected keypoint.

19. The method of claim 11, wherein interpolating the descriptor values comprises bilinearly interpolating the descriptor values.

20. The method of claim 11, further comprising obtaining, by one or more image sensors of the device, the one or more images of the scene comprising the one or more objects.
